(19) United States
(12) Patent Application Publication
(10) Pub. No.: US 2026/0089225 A1
(43) Pub. Date: Mar. 26, 2026

(54) MANAGING APPLICATION CONTEXT RELOCATION SELECTION IN EDGE NETWORK

(71) Applicant: Samsung Electronics Co., Ltd., Suwon-si, Gyeonggi-do (KR)

(72) Inventors: Sapan Pramodkumar SHAH, Bangalore (IN); Basavaraj Jayawant PATTAN, Bangalore (IN)

(21) Appl. No.: 19/114,238

(22) PCT Filed: Sep. 22, 2023
(86) PCT No.: PCT/KR2023/014532

§ 371 Date: Mar. 21, 2025

(30) Foreign Application Priority Data
Sep. 23, 2022 (IN) 202241054472
Nov. 6, 2022 (IN) 202241063335
Sep. 7, 2023 (IN) 2022 41054472
Sep. 7, 2023 (IN) 202342060293

(51) Int. Cl. H04L 67/51; H04L 9/40; H04L 67/1001

(52) U.S. Cl. CPC H04L 67/51; H04L 63/083; H04L 63/123; H04L 67/1001

(57) ABSTRACT

The disclosure relates to a 5G or 6G communication system for supporting a higher data transmission rate. A first edge enabler server (EES) transmits, to a second EES, a first message requesting an application context relocation (ACR) scenario selection, receives, from the second EES, a second message in response to the first message, wherein the second message comprises a list of ACR scenarios selected by the second EES, and transmits, to an edge enabler client (EEC), a third message comprising the list of ACR scenarios selected by the second EES based on the second message.

### TECHNICAL FIELD

The present disclosure relates to a wireless network. More particularly relates to a system and a method for managing an Application Context Relocation (ACR) selection in an edge network of the wireless network. Also, more particularly relates to a system and a method for managing an application context relocation between edge and cloud deployments.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

In a first aspect of the disclosure, provided herein is a method performed by a first edge enabler server (EES), the method comprising: transmitting, to a second EES, a first message requesting an application context relocation (ACR) scenario selection; receiving, from the second EES, a second message in response to the first message, wherein the second message comprises a list of ACR scenarios selected by the second EES; and transmitting, to an edge enabler client (EEC), a third message comprising the list of ACR scenarios selected by the second EES based on the second message.

In a second aspect of the disclosure, provided herein a first edge enabler server (EES) comprising: a transceiver; and at least one processor coupled to the transceiver, configured to: transmit, through the transceiver, to a second EES, a first message requesting an application context relocation (ACR) scenario selection, receive, through the transceiver, from the second EES, a second message in response to the first message, wherein the second message comprises a list of ACR scenarios selected by the second EES, transmit, through the transceiver, to an edge enabler client (EEC), a third message comprising the list of ACR scenarios selected by the second EES based on the second message.

In a third aspect of the disclosure, provided herein a method performed by a second edge enabler server (EES), the method comprising: receiving, from a first EES, a first message requesting an application context relocation (ACR) scenario selection; selecting at least one ACR scenario from a plurality of ACR scenarios; obtaining a list of ACR scenarios based on the selected at least one ACR scenario; and transmitting, to the first EES, a second message in response to the first message, wherein the second message comprises the list of ACR scenarios.

In a fourth aspect of the disclosure, provided herein a second edge enabler server (EES) comprising: a transceiver; and at least one processor coupled to the transceiver, configured to: receive, through the transceiver, from a first EES, a first message requesting an application context relocation (ACR) scenario selection, select at least one ACR scenario from a plurality of ACR scenarios, obtaining a list of ACR scenarios based on the selected at least one ACR scenario, transmit, through the transceiver, to the first EES, a second message in response to the first message, wherein the second message comprises the list of ACR scenarios.

In a fifth aspect of the disclosure, provided herein a method performed by an edge enabler client (EEC), the method comprising: receiving, from a first edge enabler server (EES), a third message comprising a list of application context relocation (ACR) scenarios selected by a second EES; and selecting an ACR scenario based on supported ACR scenarios of an application client (AC), the EEC, a second EES, and a second edge application server (EAS).

In a sixth aspect of the disclosure, provided herein an edge enabler client (EEC) comprising: a transceiver; and at least one processor coupled to the transceiver, configured to: receive, through the transceiver, from a first edge enabler server (EES), a third message comprising a list of application context relocation (ACR) scenarios selected by a second EES, select an ACR scenario considering supported ACR scenarios of an application client (AC), the EEC, a second EES, and a second edge application server (EAS).

### BRIEF DESCRIPTION OF DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1 is an architecture with a Cloud Application Server (CAS) and without Cloud Enabler Server (CES), according to an embodiment of the disclosure;

FIG. 2 illustrates an application architecture with Edge and Cloud server deployment, according to an embodiment of the disclosure;

FIG. 3 is a block diagram of a first Edge Enabler Server (EES), according to an embodiment of the disclosure;

FIG. 4 is a block diagram of an Edge Enabler Client (EEC), according to an embodiment of the disclosure;

FIG. 5 is flow chart illustrating a method for sending an Application Context Relocation (ACR) notification message to an EEC, according to an embodiment of the disclosure;

FIG. 6 is flow chart illustrating a method for selecting the list of ACR mechanisms based on received ACR notification message, according to an embodiment of the disclosure;

FIG. 7 is flow chart illustrating a method for sending a push request message to the second EES, according to an embodiment of the disclosure;

FIG. 8 is flow chart illustrating a method for sending a request message to the second Edge Application Server (EAS) for performing ACR selection, according to an embodiment of the disclosure;

FIG. 9 illustrates service provisioning procedure based on request/response model, according to an embodiment of the disclosure;

FIG. 10 illustrates procedure for fetching Target-Edge Application Server (T-EAS) information, according to an embodiment of the disclosure;

FIG. 11 ill illustrates the procedure for the Source-Edge Enabler Server (S-EES) to retrieve the Target-Edge Enabler Server (T-EES) information from the Edge Configuration Server (ECS), according to an embodiment of the disclosure;

FIG. 12 illustrates a scenario in which the User Equipment (UE) moving from one Edge Data Network (EDN) to Cloud Data Network (DN) then to another EDN, according to an embodiment of the disclosure;

FIG. 13 shows various hardware components of an ECS, according to an embodiment of the disclosure;

FIG. 14 shows various hardware components of a source EAS, according to an embodiment of the disclosure;

FIG. 15 is a flow chart illustrating a method, implemented by the ECS, for managing the ACR to a cloud, according to an embodiment of the disclosure;

FIG. 16 is another flow chart illustrating a method, implemented by source EES, for managing the ACR to the cloud, according to an embodiment of the disclosure;

FIG. 17 is another flow chart illustrating a method, implemented by the ECS, for managing the ACR to the cloud, according to an embodiment of the disclosure; and

FIG. 18 is another flow chart illustrating a method, implemented by the source EAS, for managing the ACR to the cloud, according to an embodiment of the disclosure.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the disclosure. Furthermore, the elements may have been represented in the drawing by conventional symbols, and the drawings may show only those specific details that are pertinent to the understanding the embodiments of the disclosure so as not to obscure the drawing with details that will be readily apparent to those of ordinary skill in the art having benefit of the description herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

Accordingly, the embodiments disclose a method for a method for managing an Application Context Relocation (ACR) selection in an edge network. The method includes determining, by a first Edge Enabler Server (EES) of a plurality of EESs, completion of a ACR operation and generating a push request message includes an identity of the first EES, information of security credentials, an Edge Enabler Client (EEC) context, an identity of a second Edge Application Server (EAS), a second EAS endpoint, an indication to select a ACR mechanisms with respect to the EEC context, and currently selected ACR mechanisms. Further, the method includes sending the push request message to a second EES of the plurality of EESs. The method includes receiving a push response message from the second EES in response to the push request message sent to the second EES. The push response message includes a list of ACR mechanisms selected by the second EES. Also, the method includes sending an ACR notification message to an EEC. The ACR notification message includes a list of identity of Application Clients (ACs), a second Edge Application Server (EAS) profile, a second EES profile along with the list of ACR mechanisms selected by the second EES, supported ACR mechanisms by the second EAS, supported ACR mechanisms by second EES based on push response message received from the second EES.

Accordingly, the embodiments disclose a method for managing ACR selection in the edge network. The method includes receiving, by the EEC, the ACR notification message from the first EES of the plurality of EESs. The ACR notification message includes the list of identity of ACs, the second EAS profile, the second EES profile along with the list of ACR mechanisms selected by the second EES. The method includes determining whether the ACR mechanisms supported by the second EAS and the ACR mechanisms supported by the second EES is available based on received ACR notification message. Further, the method includes performing one of selecting the list of ACR mechanisms based on received ACR notification message, when the ACR mechanisms supported by the second EAS and the ACR mechanisms supported by the second EES is available and sending a request message to the first EES for managing the ACR selection based on received ACR notification message, when one of the ACR mechanisms supported by the second EES and the ACR mechanisms supported by the second EAS is not available. The request message includes the ACR mechanisms supported by the EEC and the ACR mechanisms supported by the AC.

Accordingly, the embodiments disclose the first EES for managing the ACR mechanisms selection in the edge network. The first EES includes a memory, a processor coupled to the memory. A first EES controller coupled to the memory and the processor. The first EES controller determines completion of the ACR operation. The first EES controller generates the push request message includes the identity of the first EES, information of security credentials, the Edge Enabler Client context, the identity of a second Edge Application Server (EAS), the second EAS endpoint, the indication to select the ACR mechanisms with respect to the EEC context, and currently selected ACR mechanisms. The first EES controller sends the push request message to the second EES of the plurality of EESs. Further, the first EES controller receives the push response message from the second EES in response to the push request message sent to the second EES. The push response message includes the list of ACR mechanisms selected by the second EES. Also, the first EES controller sends an ACR notification message to the EEC. The ACR notification message includes the list of identity of ACs, the second EAS profile, the second EES profile along with the list of ACR mechanisms selected by the second EES, supported ACR mechanisms by the second EAS, supported ACR mechanisms by second EES based on push response message received from the second EES.

Accordingly, the embodiments disclose the EEC for managing ACR selection in the edge network. The EEC includes a memory, a processor coupled to the memory, an EEC controller coupled to the memory and the processor. The EEC controller receives the ACR notification message from the first EES of the plurality of EESs. The ACR notification message includes the list of identity of ACs, the second EAS profile, the second EES profile along with the list of ACR mechanisms selected by the second EES. The EEC controller determines whether the ACR mechanisms supported by the second EAS and the ACR mechanisms supported by the second EES is available based on received ACR notification message. Further, the EEC controller perform one of: select the list of ACR mechanisms based on received ACR notification message, when the ACR mechanisms supported by the second EAS and the ACR mechanisms supported by the second EES is available and send a request message to the first EES for managing the ACR selection based on received ACR notification message, when one of the ACR mechanisms supported by the second EES and the ACR mechanisms supported by the second EAS is not available. The request message comprises the ACR mechanisms supported by the EEC and the ACR mechanisms supported by the Application Client (AC).

3rd Generation Partnership Project (3GPP) is developing a technical specification (3GPP TS 23.558 V18.0.0) that provides application layer architecture and related procedures for enabling edge applications over 3GPP networks for a User Equipment (UE). When the UE moves to a new location, different Edge Application Servers (EASs) may be more suitable for serving Application Clients (ACs) in the UE. To support service continuity, the application context is transferred from the Source-Edge Application Server (S-EAS) to the Target-Edge Application Server (T-EAS). Capabilities for supporting the service continuity provided at an edge enabler layer may consider various application layer scenarios in which there may be involvement of the ACs and one or more EAS(s). Since the EAS may have service area restriction, once the UE is moving out of the current edge coverage, to keep service continuity, the application client needs to connect to either another EAS in new Edge Data Network (EDN) or the Cloud Application Server (CAS). 3GPP TS 23.558 V18.0.0 specifies application switching from one EAS within an EDN to another EAS in new EDN. 3GPP TR 23.700-98 V1.3.0 specifies application switching between EAS on the edge/EDN and the cloud application server (CAS). Further, 3GPP TR 23.700-98 V1.3.0 also specifies that switching between EAS and CAS is possible with and without Central Enabler Server (CES). However, it is desirable to switch between EAS and CAS with the help of CES only when requested by the application layer.

In an embodiment of the disclosure, the EEC can provide the indication (about ACR to cloud or to provide CAS information) in EAS discovery message or EEC registration message or any other message.

In an embodiment of the disclosure, the ECS provides the CES information if EES is not found, based on local policy or configuration. In an embodiment, the Edge Configuration Server (ECS) provides the CES information in the Service provisioning notification, based on indication or local policy or configuration. In an embodiment of the disclosure, S-EAS may include the indication in the Discover T-EAS request for Source-Edge Enabler Server (S-EES) to provide CAS information, if T-EAS is not found. In an embodiment of the disclosure, S-EAS may include the indication about ACR to Cloud and repeat the Discover T-EAS procedure.

The terms “first EES” and “source EES” are used interchangeably throughout the disclosure. The terms “second EES” and “target EES” are used interchangeably throughout the disclosure. The terms “second EAS” and “target EAS” are used interchangeably throughout the specification.

The conventional methods have multiple gaps regarding selection of ACR mechanisms. For example, during ACR selection, which entity (EEC or EES) going to select the ACR mechanisms list for the AC-EAS pair is not clear. Also, how the ACR mechanisms is selected not clear, when the EEC or EES does not have sufficient information to select the ACR mechanisms for the AC-EAS pair. Further, the existing methods are not clear about the way of selecting a new list of ACR mechanisms including the T-EES and a T-EAS supported ACR mechanisms, when the UE moves out of the service area of the EES or the EAS and when the actual ACR is performed. The proposed invention provides a solution to the above gap without the incomplete service continuity feature and without service interruption of user experiences. For example, a person playing a game using a User Equipment (UE) that is connected with the source EES. At the start of the game, either EEC or source EES performs ACR mechanisms selection which is being used during the game to perform ACR. When the person moves from one location to another location, the UE and the source EES performs ACR based on currently selected ACR mechanisms. Once ACR is performed, the UE is now connected to target EES and target EAS. However, the current (or initial) selection of ACR mechanisms may not be valid considering the target EES and the target EAS. Once the UE successfully handover from the source EES to the target EES, the ACR selection between the UE and the target EES is not clear.

Unlike the conventional methods, the solution provides methods for selecting ACR mechanisms considering supported mechanisms of new EES and new EAS, after service continuity procedure is completed. The proposed method allows the EEC and the target EES to select the ACR mechanisms. Further, the proposed method allows sharing the newly selected ACR mechanisms towards EEC and allows sharing newly selected ACR mechanisms towards EES. For example, a person playing a game using a User Equipment (UE) that is connected with the source EES. At the start of the game, either EEC or source EES performs ACR mechanisms selection which is being used during the game to perform ACR. When the person moves from one location to another location, the UE and the source EES performs ACR based on currently selected ACR mechanisms. Once ACR is performed, the UE is now connected to target EES and target EAS. However, the current (or initial) selection of ACR mechanisms may not be valid considering the target EES and the target EAS. Once the UE successfully handover from the source EES to the target EES, the UE and the target EES uses already selected ACR mechanisms which may not be valid for the target EES and the target EAS.

In conventional methods, receiving contentious service in EDN is one of the important aspects of any deployment. In the continuity service procedures, the ACR mechanisms are selected only first time considering supported ACR mechanisms of AC, EEC, S-EES, and S-EAS. After service continuity, the EES connects to new EES (T-EES) and the AC connects to new EAS (T-EAS). The selected ACR mechanisms, which were selected considering S-EES and S-EAS, are not valid for T-EES and T-EAS. Since the ACR mechanisms are not valid, the EEC (in the UE) gets fail to receive service, when the UE moves to new area.

Unlike the conventional methods, the proposed method solves this critical problem and enhances the Edge Enabler Layer (EEL) entities behavior to select the ACR mechanisms considering ACR mechanisms supported by T-EES and T-EAS, and sharing the selected ACR mechanisms details to other entities in the EEL.

In the conventional methods, the current 3^{rd} Generation Partnership Project (3GPP) standard for enabling edge applications has critical issue where ACR mechanisms are selected only once at the time when the EEC connects to the EES for the first time or when AC connects to source EAS, the selection is based on supported ACR mechanisms of the AC, the EEC, the source EES, and the source EAS.

Unlike the conventional methods, the proposed method improves the Edge Enabler Layer (EEL) by selecting new ACR mechanisms after completing service continuity procedure by considering supported ACR mechanisms of AC, EEC, T-EES and T-EAS.

In general, edge computing is an essential concept for a 5^{th} Generation (5G) which allows to reduce the latency by enabling services to be hosted close to service consumers. The 5G is expected to have data transmission speed increased by multiple times compared to previous generation networks. In order to reduce the latency, the edge computing is essential which brings the computing resources near to the end users. The Edge Enabler Layer (EEL) exposes Application Programming Interfaces (APIs) to support capabilities like service provisioning, registration, application server discovery, capability exposure to Application Server (AS), and support for service continuity. The Application Clients (ACs) in the User Equipment (UE) are able to locate and connect with the most suitable Edge Application Server (EAS) available in the Edge Data Network (EDN), using the capabilities provided by the EEL.

In the EEL, when the UE moves from one location to a new location, the EAS which is connected to AC (in the UE) needs to be replaced with another EAS depending on the service area, to provide a better service experience to the user and the UE.

The EEL provides a service continuity feature for minimizing the application layer service interruption. The service continuity feature is supported by defining information elements and procedures for Application Context Relocation (ACR). The ACR procedures enable the transfer of the Edge Enabler Client (EEC) context from a Source-Edge Enabler Server (S-EES) to a Target-EES (T-EES).

Currently, the EDN supports different types of ACR mechanisms but is not limited to ACR Initiation by EEC using regular EAS Discovery, EEC executed ACR via S-EES, S-EAS decided ACR mechanisms, S-EES executed ACR and EEC executed ACR via T-EES. For each ACR mechanisms, entities are responsible to detect, decide, and execute the ACR. Instead of allowing detection for all the ACR mechanisms, a few ACR mechanisms are selected either by EEC or EES which performs ACR detection activity. The selection of specific ACR mechanisms is specified in order to avoid multiple ACR execution which leads to the service continuity failure.

However, the existing methods have multiple gaps regarding selection of ACR mechanisms. For example, during ACR selection, which entity (EEC or EES) going to select the ACR mechanisms list for the AC-EAS pair is not clear. Also, how the ACR mechanisms is selected is not clear, when the EEC or EES does not have sufficient information to select the ACR mechanisms for the AC-EAS pair. Further, the existing methods are not clear about the way of selecting a new list of ACR mechanisms including the T-EES and a T-EAS supported ACR mechanisms, when the UE moves out of the service area of the EES or the EAS and when the actual ACR is performed. The proposed invention provides a solution to the above gap without the incomplete service continuity feature and without service interruption of user experiences.

Further, a 3^{rd} Generation Partnership Project (3GPP) is developing a technical specification (3GPP TS 23.558 V18.0.0) that provides application layer architecture and related procedures for enabling edge applications over 3GPP networks for a User Equipment (UE). When the UE moves to a new location, different Edge Application Servers (EASs) may be more suitable for serving Application Clients (ACs) in the UE. To support service continuity, the application context is transferred from the S-EAS to the T-EAS. Capabilities for supporting the service continuity provided at an edge enabler layer may consider various application layer scenarios in which there may be involvement of the ACs and one or more EAS(s).

Since the EAS may have service area restriction, once the UE is moving out of the current edge coverage, to keep service continuity, the application client needs to connect to either another EAS in new Edge Data Network (EDN) or the Cloud Application Server (CAS). The 3GPP TS 23.558 V18.0.0 specifies application switching from one EAS within an EDN to another EAS in new EDN. The 3GPP TR 23.700-98 V1.3.0 specifies application switching between EAS on the edge/EDN and the cloud application server (CAS). Further, 3GPP TR 23.700-98 V1.3.0 also specifies that switching between EAS and CAS is possible with and without Central Enabler Server (CES). However, it is desirable to switch between EAS and CAS with the help of CES only when requested by the application layer.

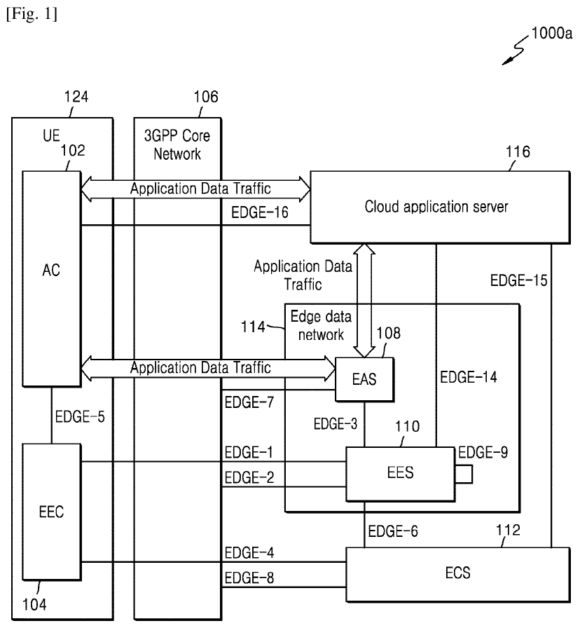

FIG. 1 is an architecture (1000a) with Cloud Application Server (CAS) (116) and without CES, according to an embodiment of the disclosure. A 3rd Generation Partnership Project (3GPP) is developing a technical specification (3GPP TS 23.558 V18.0.0) that provides application layer architecture and related procedures for enabling edge applications over 3GPP networks for a User Equipment (UE). When the UE moves to a new location, different Edge Application Servers (EASs) (108) may be more suitable for serving Application Clients (ACs) (102) in the UE (124). To support service continuity, the application context is transferred from the S-EAS to the T-EAS. Capabilities for supporting the service continuity provided at an edge enabler layer may consider various application layer scenarios in which there may be involvement of the ACs (102) and one or more EASs (108).

In deployments, service rendering may be unavailable via the EAS (108) (e.g., S-EAS, T-EAS, etc.) at certain geographic locations, for example, due to the EAS (108) being overloaded, the EAS (108) not being deployed, the EAS (108) being shut down, or an Edge Data Network (EDN) (114) not being available. In such cases, a user of the UE's edge applications receives unreliable services (no service continuity) from the edge/EDN as suitable S-EAS/T-EAS is not available for a current location and/or the new location of the UE (124), which degrades user's experience. Furthermore, the user of the UE's edge applications wishes to keep receiving service from a cloud application server (116) as the suitable S-EAS/T-EAS is not available for the current location and/or the new location of the UE (124).

Since the EAS (108) may have service area restriction, once the UE (124) is moving out of the current edge coverage, to keep service continuity, the application client (102) needs to connect to either another EAS (108) in new Edge Data Network (EDN) (114) or the Cloud Application Server (CAS) (116). 3GPP TS 23.558 V18.0.0 specifies application switching from one EAS (108) within an EDN (114) to another EAS (108) in new EDN (114). 3GPP TR 23.700-98 V1.3.0 specifies application switching between EAS (108) on the edge/EDN (114) and the CAS (116). Further, 3GPP TR 23.700-98 V1.3.0 also specifies that switching between EAS (108) and CAS (116) is possible with and without Central Enabler Server (CES). However, it is desirable to switch between EAS (108) and CAS (116) with the help of CES only when requested by the application layer.

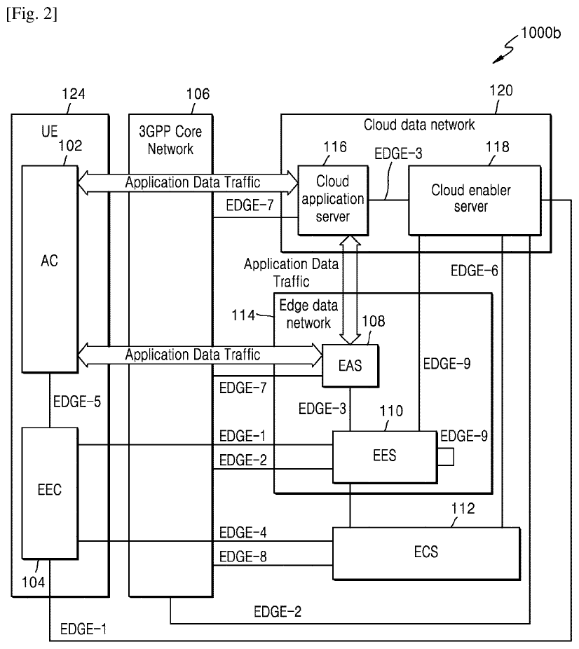

In 3GPP TR 23.700-98 V1.3.0, there are two solutions i.e. CES-less solution as shown in FIG. 1, and solution with CES as shown in FIG. 2.

FIG. 2 illustrates an application architecture (1000b) with Edge and Cloud server deployment, according to an embodiment of the disclosure.

With CES, ACR feature parity can be supported in the ACR between CAS (116) and EAS (108) utilizing all EDGEAPP developed features (e.g. AS discovery, AS registration). Comparing to CES-less solution, it needs a new function entity in the central DN to support CAS (116), and CES is part of the EEL. The CES has the same functions as the EES (110) without having service area restriction. The CAS (116) registers in CES in order to be discoverable by the EEC (104) using EDGEAPP EAS discovery mechanism, the CES registers in ECS (112) in order to be discoverable by the EEC (104) using EDGEAPP service provisioning procedure. CAS registration to CES is an additional functionality that need to be supported for all CAS(s) (116).

For CES-less solution as described in solution #25 of 3GPP TR 23.700-98 V1.3.0, it has a mixed use of regular Domain Name System (DNS) query and EDGEAPP EAS discovery. When a T-EAS cannot be discovered using the EDGEAPP mechanism, EDGEAPP entities (e.g. AC) falls back to regular DNS query. It supports ACR scenarios as described in solution #25 of 3GPP TR 23.700-98 V1.3.0 for ACR from EAS (108) to the CAS (116), it also supports ACR scenarios for ACR from the CAS (116) to the EAS (108).

The CES can be considered as an optional entity in the EDGEAPP architecture. They share the same EDGEAPP EAS discovery/service provisioning procedure when trying to discover appropriate EAS (108). When there is CES available and registered in the ECS (112) in the network, the EDGEAPP mechanism returns CES in service provisioning response to the EEC/S-EES or the S-EAS obtains CAS (116) from CES via S-EES and EDGEAPP mechanism follows; otherwise, regular DNS is used to find CAS (116) due to EDGEAPP mechanism failure (no EES configuration or T-EAS is not discoverable).

The operations and functions of the architecture (1000a and 1000b) are well known in the ordinary skilled in the art. Hence, for the sake of the clarity, the operations and functions are not repeated again in the patent disclosure.

Thus, it is desired to address the above-mentioned disadvantages or other shortcomings or at least provide a useful alternative.

The principal object of the embodiments herein is to provide a system and method for managing an ACR selection in an edge network. In the proposed solution, a first EES sends an ACR notification message to an EEC for reselecting a list of ACR mechanisms to avoid confusion among the EEC and a second EES during the ACR selection.

Another object of the embodiments herein is to provide a method for sending a request message to a second EES for performing ACR mechanisms selection.

Another object of the embodiments herein is to provide a method for sending a request message to a second EAS for performing ACR selection when the list of ACR mechanisms supported by the EEC and the list of ACR mechanisms supported by an EES is not available for second EAS to overcome the unclear situation of the ACR mechanisms.

Another objective of the embodiments herein is to provide a method for managing an application context relocation between edge and cloud deployments.

Another objective of the embodiments herein is to provide an ECS that provides the CES information when the EES is not found, based on local policy or configuration.

Another objective of the embodiments herein is to provide an ECS that provides the CES information in the Service provisioning response, based on indication or local policy or configuration.

Another objective of the embodiments herein is to provide an ECS that provides the CES information in the Service provisioning notification, based on indication or local policy or configuration.

Another objective of the embodiments herein is to provide a S-EAS that include the indication in the Discover T-EAS request for S-EES to provide CAS information, when T-EAS is not found.

Another objective of the embodiments herein is to provide a S-EAS that the indication about ACR to Cloud and repeat the Discover T-EAS procedure.

Another objective of the embodiments herein is to provide a EEC that include the indication in the service provisioning request for ECS to provide CES information, when EES is not found.

Another objective of the embodiments herein is to provide a EES that include the indication in the retrieve T-EES request for ECS to provide CES information, when EES is not found.

In an embodiment of the disclosure, the objectives are achieved by providing a method for managing an ACR mechanisms selection in an edge network. The method includes determining, by a first EES of a plurality of EESs, completion of an ACR operation and generating a push request message includes an identity of the first EES, information of security credentials, an EEC context, an identity of a second Edge Application Server (EAS) of a plurality of EASs, a second EAS endpoint, an indication to select an ACR mechanisms with respect to the EEC context and currently selected ACR mechanisms. Further, the method includes sending the push request message to a second EES of the plurality of EESs. The method includes receiving a push response message from the second EES in response to the push request message sent to the second EES. The push response message includes a list of ACR mechanisms selected by the second EES. Also, the method includes sending an ACR notification message to an EEC. The ACR notification message includes a list of identity of ACs, a second EAS profile, a second EES profile along with the list of ACR mechanisms selected by the second EES, supported ACR mechanisms by the second EAS, supported ACR mechanisms by second EES based on push response message received from the second EES.

In an embodiment of the disclosure, the method includes selecting the list of ACR mechanisms based on supported ACR mechanisms by an Application Client (AC), the EEC, the second EES and the second EAS, when the indication to select an ACR mechanisms with respect to the EEC context is received from the first EES. Further, the method includes sending a notification message to the second EAS comprises the list of ACR mechanisms.

In an embodiment of the disclosure, the method includes determining the completion of the ACR operation and receiving the ACR notification message from the first EES. Further, the method includes determining the list of ACR mechanisms selected by the second EES is not available based on received ACR notification message from the first EES. Also, the method includes selecting the list of ACR mechanisms based on received ACR notification message, when the list of ACR mechanisms selected by the second EES is not available in ACR notification message. Further, the method includes sending the selected list of ACR mechanisms to the first EES.

In an embodiment of the disclosure, the method includes enabling the EEC to select list of ACR mechanisms for the AC, the EEC, the second EES and the second EAS.

In an embodiment of the disclosure, the method includes initiating the ACR operation using the EEC performed ACR through the first EES. The method includes selecting the list of ACR mechanisms based on the AC, the EEC, the second EES and a second EAS. Further, the method includes sending a request message to the first EES as a part of the initiation of the ACR operation. The request message includes the list of ACR mechanisms selected by the EEC. The method includes determining initiation of the ACR operation includes the list of ACR mechanisms selected by the EEC based on received request message from the EEC. Also, the method includes sending the push request message to the second EES including the list of ACR mechanisms selected by the EEC based on received request message from the EEC. The method includes sending a notification message to the second EAS comprises the list of ACR mechanisms.

In an embodiment of the disclosure, the method includes the list of ACR mechanisms includes an ACR initiation by the EEC using EAS Discovery, the EEC performed ACR through the first EES, the first EES decided the ACR mechanisms, the first EES performed the ACR mechanisms and the EEC performed the ACR through the second EES.

In an embodiment of the disclosure, the method includes the EEC context includes information of the list of ACR mechanisms selected for the second EAS where the AC is connected and receiving a service.

In an embodiment of the disclosure, the method includes indicating the EEC to continue using a current list of ACR mechanisms, when the second EES accepts the current list of ACR mechanisms.

In an embodiment of the disclosure, the objectives are achieved by providing a method for managing ACR selection in the edge network. The method includes determining whether the ACR mechanisms supported by the second EAS and the ACR mechanisms supported by the second EES is available. Further, the method includes performing one of selecting the list of ACR mechanisms, when the ACR mechanisms supported by the second EAS and the ACR mechanisms supported by the second EES is available and sending a request message to the first EES for managing the ACR selection based on received ACR notification message, when one of the ACR mechanisms supported by the second EES and the ACR mechanisms supported by the second EAS is not available. The request message includes the ACR mechanisms supported by the EEC and the ACR mechanisms supported by the AC.

In an embodiment of the disclosure, the method includes the list of ACR mechanisms includes an ACR initiation by the EEC using the EAS Discovery, the EEC executed ACR through the first EES, the first EES decided the ACR mechanisms, the first EES executed the ACR mechanisms and the EEC executed the ACR mechanisms through the second EES.

In an embodiment of the disclosure, the method includes performing an EAS discovery, a service provisioning, and an EES registration. Further, the method includes selecting an EAS of the plurality of EASs in response to performed EAS discovery.

In an embodiment of the disclosure, the method includes determining, by an EES of a plurality of EESs, whether the ACR mechanisms supported by the EEC and the ACR mechanisms supported by the EAS is available for the EES. The method includes performing one of: selecting the list of ACR mechanisms and sending information of the list of ACR mechanisms selected by the EES to the EEC and the EAS, when the ACR mechanisms supported by the EEC and the ACR mechanisms supported by the EAS is available for the EES and sending a request message to the EAS for performing ACR selection, when the ACR mechanisms supported by the EAS is not available for the EES. The request message includes the list of ACR mechanisms supported by the EEC and the list of ACR mechanisms supported by the EES.

In an embodiment of the disclosure, the method includes selecting the list of ACR mechanisms based on the request message received from the EES.

In an embodiment of the disclosure, the objectives are achieved by the first EES for managing the ACR mechanisms selection in the edge network. The first EES includes a memory, a processor coupled to the memory. A first EES controller coupled to the memory and the processor. The first EES controller determines completion of the ACR operation. The first EES controller generates the push request message includes the identity of the first EES, information of security credentials, the Edge Enabler Client context, the identity of a second Edge Application Server (EAS), the second EAS endpoint, the indication to select the ACR mechanisms with respect to the EEC context and currently selected ACR mechanisms. The first EES controller sends the push request message to the second EES of the plurality of EESs. Further, the first EES controller receives the push response message from the second EES in response to the push request message sent to the second EES. The push response message includes the list of ACR mechanisms selected by the second EES. Also, the first EES controller sends an ACR notification message to the EEC. The ACR notification message includes the list of identity of ACs, the second EAS profile, the second EES profile along with the list of ACR mechanisms selected by the second EES, supported ACR mechanisms by the second EAS, supported ACR mechanisms by second EES based on push response message received from the second EES.

In an embodiment of the disclosure, the second EES: select the list of ACR mechanisms based on supported ACR mechanisms by an Application Client (AC), the EEC, the second EES and a second EAS, when the indication to select a ACR mechanisms with respect to the EEC context is received from the first EES; and send a notification message to the second EAS comprises the list of ACR mechanisms.

In an embodiment of the disclosure, the EES controller: determine the completion of the ACR operation; receive the ACR notification message from the first EES; select the list of ACR mechanisms based on received ACR notification message, when the list of ACR mechanisms selected by the second EES is not available in ACR notification message; and send the selected list of ACR mechanisms to the first EES.

In an embodiment of the disclosure, the EES controller enables the EEC to select list of ACR mechanisms for the AC, the EEC, the second EES and the second EAS.

In an embodiment of the disclosure, the EEC: initiate the ACR operation using the EEC performed ACR through the first EES; select the list of ACR mechanisms supported by the AC, the EEC, the second EES and a second EAS; send a request message to the first EES as a part of the initiation of the ACR operation, wherein the request message comprises the list of ACR mechanisms selected by the EEC; determine initiation of the ACR operation comprises the list of ACR mechanisms selected by the EEC based on received request message from the EEC; send the push request message to the second EES including the list of ACR mechanisms selected by the EEC based on received request message from the EEC; and send the notification message to the second EAS comprises the list of ACR mechanisms.

In an embodiment of the disclosure, the list of ACR mechanisms comprises an ACR initiation by the EEC using EAS Discovery, the EEC performed ACR through the first EES, the first EES decided the ACR mechanisms, the first EES performed the ACR mechanisms and the EEC performed the ACR through the second EES.

In an embodiment of the disclosure, the EEC context comprises information of the list of ACR mechanisms selected for the second EAS where the AC is connected and receiving a service.

In an embodiment of the disclosure, the method comprises: indicate the EEC to continue using a current list of ACR mechanisms, when the second EES accepts the current list of ACR mechanisms.

In an embodiment of the disclosure, the objects are achieved by the EEC for managing ACR selection in the edge network. The EEC includes a memory, a processor coupled to the memory, an EEC controller coupled to the memory and the processor. The EEC controller determines whether the ACR mechanisms supported by the second EAS and the ACR mechanisms supported by the second EES is available. Further, the EEC controller perform one of: select the list of ACR mechanisms, when the ACR mechanisms supported by the second EAS and the ACR mechanisms supported by the second EES is available and send a request message to the first EES for managing the ACR selection based on received ACR notification message, when one of the ACR mechanisms supported by the second EES and the ACR mechanisms supported by the second EAS is not available. The request message comprises the ACR mechanisms supported by the EEC and the ACR mechanisms supported by the AC.

In an embodiment of the disclosure, the list of ACR mechanisms comprises an ACR initiation by the EEC using EAS Discovery, the EEC executed ACR through the first EES, the first EES decided the ACR mechanisms, the first EES executed the ACR mechanisms and the EEC executed the ACR mechanisms through the second EES.

In an embodiment of the disclosure, the EEC controller: perform an EAS discovery, a service provisioning, and a EES registration; and select the EAS from a plurality of EASs in response to performed EAS discovery.

In an embodiment of the disclosure, an EES of a plurality of EESs: determine whether the ACR mechanisms supported by the EEC and the ACR mechanisms supported by the EAS is available for the EES; perform one of:
select the list of ACR mechanisms and sending information of the list of ACR mechanisms selected by the EES to the EEC and the EAS, when the ACR mechanisms supported by the EEC and the ACR mechanisms supported by the EAS is available for the EES; or send a request message to the EAS for performing ACR selection, when the ACR mechanisms supported by the EAS is not available for the EES, wherein the request message comprises the list of ACR mechanisms supported by the EEC and the list of ACR mechanisms supported by the EES.

In an embodiment of the disclosure, the EAS: select the list of ACR mechanisms based on the request message received from the EES.

In an embodiment of the disclosure, the objectives are achieved by providing a method for managing an Application Context Relocation (ACR) to a cloud. The method includes receiving, by an ECS, a service provision request message to perform a service provision operation from an Edge Enabler Client (EEC). The service provisioning request includes an indication about the ACR to the cloud or an indication to provide information about a Cloud Enabler Server (CES). Further, the method includes authorizing, by the ECS, whether the EEC has authorization to perform the service provision operation based on the service provision request message. Further, the method includes determining, by the ECS, whether the CES is registered to the ECS. In an embodiment of the disclosure, the method includes sending a service provision response message to the EEC when the CES is registered to the ECS, the authorization of the EEC is successful and the request from the EEC includes an indication about the ACR to the cloud. The service provision response message includes information about the CES. In an embodiment of the disclosure, the method includes sending a service provision reject message with a cause when at least one of the authorization of the ECS is unsuccessful and the CES is not registered to the ECS.

In an embodiment of the disclosure, the indication about the ACR to the cloud or the indication to provide information about the CES is included in one of a Edge Application Server (EAS) discovery message and a EEC registration message.

In an embodiment of the disclosure, the objectives are achieved by providing a method for managing an ACR to the cloud. The method includes receiving, by an ECS, a retrieve EES request message from a source EES to identify at least one target EES which has an EAS available to serve an User Equipment (UE). The retrieve EES request message includes an indication about the ACR to the cloud or an indication to provide information about the CES. Further, the method includes determining, by the ECS, whether the CES is registered to the ECS. In an embodiment of the disclosure, the method includes sending a retrieve EES response message to the EES when the CES is registered with the ECS and the request message includes an indication about the ACR to the cloud, where the retrieve EES response message includes information about the CES information. In an embodiment of the disclosure, the method includes sending a retrieve EES reject message with a cause, when the CES is not registered with the ECS.

In an embodiment of the disclosure, the method further, includes the method includes receiving, by an source EES, a EAS discovery request message to perform a discovery operation from a source EAS. The EAS discovery request message includes an indication about the ACR to the cloud to provide information about the CAS when at least one target EAS is not available. Further, the method includes sending, by the source EES, a retrieve EES request message towards the ECS to identify at least one target EES which has an EAS available to serve the UE. The EES request message includes the indication about the ACR to the cloud or the indication to provide information about the CES. Further, the method includes receiving, by the source EES, a response to the retrieve EES request from the ECS where the response message includes the CES information. Further, the method includes sending, by the source EES, a response message to the source EAS where the response message includes the CES information.

In an embodiment of the disclosure, the method includes determining, by the source EAS, a first discovery operation for at least one target EAS fails to return the at least one target EAS. Further, the method includes performing, by the source EAS, a second discover operation by sending an EAS discovery request message to a source EES. The EAS discovery request message includes an indication about the ACR to the cloud to provide information about the CAS. Further, the method includes receiving, by the source EAS, an EAS discovery response message from the source EES. The EAS discovery response message includes information about at least one target EAS associated with the at least one target EES.

In an embodiment of the disclosure, the objectives are achieved by providing a ECS for managing an ACR to cloud. The ECS includes an ACR-cloud controller coupled to a memory and a processor. The ACR-cloud controller is configured to receive a service provision request message to perform a service provision operation from an EEC. The service provisioning request includes an indication about the ACR to the cloud or an indication to provide information about the CES. The ACR-cloud controller is configured to authorize whether the EEC has authorization to perform the service provision operation based on the service provision request message. Further, the ACR-cloud controller is configured to determine whether the CES is registered to the ECS. In an embodiment of the disclosure, the ACR-cloud controller is configured to send a service provision response message to the EEC when the CES is registered to the ECS, the authorization of the EEC is successful and the request from the EEC includes an indication about the ACR to the cloud. The service provision response message includes information about the CES. In an embodiment of the disclosure, the ACR-cloud controller is configured to send a service provision reject message with a cause when at least one of the authorization of the ECS is unsuccessful and the CES is not registered to the ECS.

In an embodiment of the disclosure, the objectives are achieved by providing an edge network for managing an ACR to cloud. The edge network having a ECS includes an ACR-cloud controller coupled to a memory and a processor. The ACR-cloud controller is configured to receive a retrieve EES request message from a source EES to identify at least one target EES which has an EAS available to serve an User Equipment (UE). The retrieve EES request message includes an indication about the ACR to the cloud or an indication to provide information about the CES. Further, the ACR-cloud controller is configured to determine whether the CES is registered to the ECS. In an embodiment, the ACR-cloud controller is configured to send a retrieve EES response message to the EES when the CES is registered with the ECS and the request message includes an indication about the ACR to the cloud. The retrieve EES response message includes information about the CES information. In another embodiment, the ACR-cloud controller is configured to send a retrieve EES reject message with a cause, when the CES is not registered with the ECS.

In an embodiment of the disclosure, the source EES includes an ACR-cloud controller coupled to a memory and a processor. The ACR-cloud controller is configured to receive a EAS discovery request message to perform a discovery operation from a source EAS. The EAS discovery request message includes an indication about the ACR to the cloud to provide information about the CAS when at least one target EAS is not available at the source EAS. Further, the ACR-cloud controller is configured to send a retrieve EES request message towards the ECS to identify at least one target EES which has an EAS available to serve the UE. The retrieve EES request message includes the indication about the ACR to the cloud or the indication to provide information about the CES. Further, the ACR-cloud controller is configured to receive a response to the retrieve EES request from the ECS where the response message includes the CES information. Further, the ACR-cloud controller is configured to send a response message to the source EAS where the response message includes the CES information.

In an embodiment of the disclosure, the source EAS includes an ACR-cloud controller coupled to a memory and a processor. The ACR-cloud controller is configured to determine a first discovery operation for at least one target EAS failing to return the at least one target EAS. Further, the ACR-cloud controller is configured to perform a second discover operation by sending an EAS discovery request message to a source EES. The EAS discovery request message includes an indication about the ACR to the cloud to provide information about the CAS. Further, the ACR-cloud controller is configured to receive an EAS discovery response message from the source EES, where the EAS discovery response message includes information about at least one target EAS associated with the at least one target EES.

These and other aspects of the embodiments herein will be better appreciated and understood when considered in conjunction with the following description and the accompanying drawings. It is understood, however, that the following descriptions, while indicating preferred embodiments and numerous specific details thereof, are given by way of illustration and not of limitation. Many changes and modifications be made within the scope of the embodiments herein without departing from the scope thereof, and the embodiments herein include all such modifications.

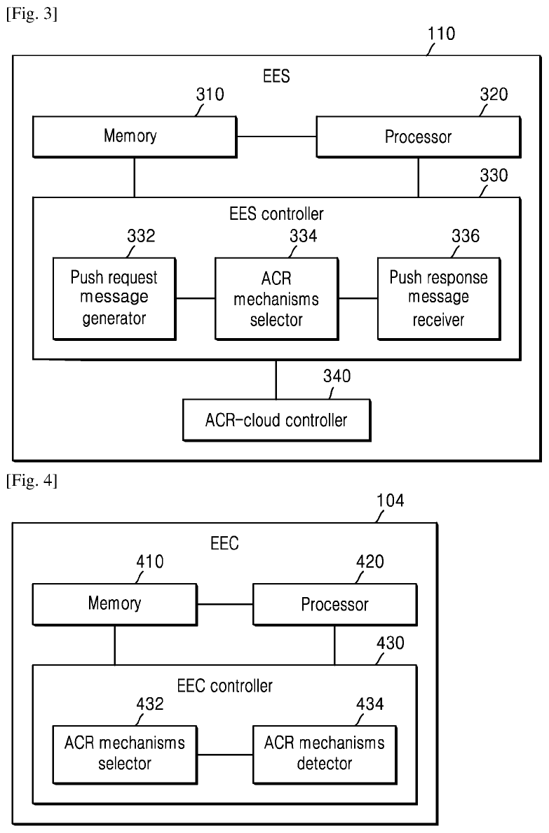

Referring now to the drawings and more particularly to FIGS. 3 through 18, where similar reference characters denote corresponding features consistently throughout the figure, these are shown preferred embodiments.

FIG. 3 is a block diagram of a first EES (110), according to an embodiment of the disclosure. The first EES (110) includes a memory (310), a processor (320), and an EES controller (330). The EES controller (330) determines completion of an ACR operation and generates a push request message includes an identity of the first EES, information of security credentials, an Edge Enabler Client (EEC) context, an identity of a selected second Edge Application Server (EAS) (108) of a plurality of EASs, a second EAS (108) endpoint, an indication to select an ACR mechanisms with respect to the EEC context, and currently selected ACR mechanisms. The EES controller (330) sends the push request message to a second EES (not shown in figures) of the plurality of EESs. The EES controller (330) receives a push response message from the second EES in response to the push request message send to the second EES. The push response message includes a list of ACR mechanisms selected by the second EES. The EES controller (330) sends an ACR notification message to an EEC (104). The ACR notification message includes a list of identity of ACs, a second EAS profile, a second EES profile along with the list of ACR mechanisms selected by the second EES, supported ACR mechanisms by the second EAS (108), supported ACR mechanisms by the second EES based on push response message received from the second EES.

In an embodiment of the disclosure, the list of ACR mechanisms includes ACR initiation by the EEC (104) using EAS (108) Discovery, the EEC (104) performed ACR through the first EES, the first EES decided the ACR mechanisms, the first EES performed the ACR mechanisms and the EEC performed the ACR through the second EES.

In the embodiment of the disclosure, the EEC context includes information of the list of ACR mechanisms selected for the second EAS (108) where the AC (102) is connected and receiving service.

The memory (310) is configured to store instructions to be executed by the processor (320). The memory (310) includes non-volatile storage elements. Examples of such non-volatile storage elements includes magnetic hard discs, optical discs, floppy discs, flash memories, or forms of Electrically Programmable Memories (EPROM) or Electrically Erasable and Programmable Memories (EEPROM). In addition, the memory (310) in some examples, be considered a non-transitory storage medium. The term “non-transitory” indicates that the storage medium is not embodied in a carrier wave or a propagated signal. The term “non-transitory” is not be interpreted that the memory (310) is non-movable. In some examples, the memory (310) is configured to store larger amounts of information. In certain examples, a non-transitory storage medium stores data that can, over time, change (e.g., in Random Access Memory (RAM) or cache).

The processor (320) includes one or a plurality of processors. The one or the plurality of processors is a general-purpose processor, such as a central processing unit (CPU), an application processor (AP), or the like, a graphics processing unit such as a graphics processing unit (GPU), a Visual Processing Unit (VPU), and/or an AI-dedicated processor such as a neural processing unit (NPU). The processor (320) includes multiple cores and is configured to execute the instructions stored in the memory (310).

The EES controller (330) is implemented by processing circuitry such as logic gates, integrated circuits, microprocessors, microcontrollers, memory circuits, passive electronic components, active electronic components, optical components, hardwired circuits, or the like, and optionally be driven by firmware. The circuits for example, be embodied in one or more semiconductor chips, or on substrate supports such as printed circuit boards and the like.

At least one of the plurality of modules/components of the EES controller (330) is implemented through an Artificial Intelligence (AT) model. A function associated with the AI model that is performed through the memory (310) and the processor (320). The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired char-acteristic is made. The learning is performed in a device itself in which AI according to an embodiment is performed, and/or is implemented through a separate server/system.

The AI model consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), Deep Belief Network (DBN), bidirectional recurrent deep neural network (BRDNN), Generative Adversarial Networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

In an embodiment of the disclosure, the EES controller (330) includes a push request message generator (332), an ACR mechanisms selector (334), and a Push response message receiver (336). The first EES (110) determines the completion of the ACR operation. The push request message generator (332) generates the push request message includes the identity of the first EES, information of security credentials, the Edge Enabler Client (EEC) context, the identity of the selected second EAS (108), a second EAS (108) endpoint, and the indication to select the ACR mechanisms with respect to the EEC context as shown in Table. 1. The EEC context includes information of the list of ACR mechanisms selected for the first EAS (108) where the AC (102) is connected and receiving service. The first EES (110) sends the push request message to the second EES of the plurality of EESs. Upon receiving the push request message from the first EES (110), the second EES validates the request and verifies the security credential. Once the second EES validates the first EES (110), the second EES checks the list of ACR mechanisms supported by the EEC (104). When the list of ACR mechanisms selected by the EEC (104) is cannot be supported by the second EES or the second EAS (108), another list of ACR mechanisms needs to be selected based on the push request message received from the first EES (110). The second EES selects the list of ACR mechanisms based on the capabilities of the second EES, the second EAS (108) and EEC service continuity support. The Information Element (IE) has been provided in the EEC context and includes it in the push EEC context response.

The push response message receiver (336) receives the push response message from the second EES in response to the push request message sent to the second EES. The push response message includes the list of selected ACR mechanisms selected by the second EES. The first EES (110) sends the ACR notification message to the EEC (104). The ACR notification message includes the list of identity of ACs, the second EAS profile, the second EES profile along with the list of ACR mechanisms selected by the second EES, supported ACR mechanisms by the second EAS (108), supported ACR mechanisms by second EES based on push response message received from the second EES. The EEC (104) selecting the list of ACR mechanisms based on the received ACR notification message from the first EES (110).

TABLE 1

| Information element | Description |
|---|---|
| EES ID | Unique identifier of the requesting EES. |
| Security credentials | Security credentials resulting from a |
| | successful authorization for the edge |
| | computing service. |
| EEC Context | EEC Context |
| T-EAS Endpoint | The endpoint of the selected T-EAS |
| ACR mechanisms | Indicates T-EES to select the ACR |
| selection request | mechanisms. |

In an embodiment of the disclosure, when the second EES accepts the current list of ACR mechanisms, the first EES (110) indicates the EEC (104) to continue using a current list of ACR mechanisms.

In an embodiment of the disclosure, the first EES (110) sends the ACR notification message to the EEC (104) that includes the identity of the AC (102) to indicate the application context relocation of the AC (102) is complete. During the ACR operation, when the first EES (110) received the successful push response message from the second EES, the first EES (110) sends the ACR notification message to the EEC (104). The push response message includes the list of ACR mechanisms selected by the second EES in the EEC context push response relocation procedure. The ACR notification message includes the list of ACR mechanisms selected by the second EES under an EEC context relocation status (for successful status). Upon receiving the ACR notification message from the first EES (110), when the list of ACR mechanisms selected by the second EES is not available, the EEC (104) either select the ACR mechanisms by considering the supported ACR mechanisms of the AC, the EEC (104), the second EES, and the second EAS (108) or the EEC (104) requesting the second EES to select the list of ACR mechanisms.

After the ACR notification message with successful ACR operation, when the ACR notification message indicates that the EEC context relocation is failed, the EEC (104) triggers the EAS (108) information provisioning procedure to perform a re-selection of the ACR mechanisms.

In an embodiment of the disclosure, after the ACR notification message with successful ACR operation, when the EEC context is not existed, the EEC (104) triggers the EAS (108) information provisioning procedure to select the ACR mechanisms.

The ACR mechanisms selector (334) of the first EES (110) selects the list of ACR mechanisms. Basically, each EES of the plurality of EESs includes the ACR mechanisms selector (334) to select the list of ACR mechanisms, when any of the EEC context is transferred from a previous EES to a current EES of the plurality of EESs. For example, when any of the EEC context is transferred from the previous EES (not shown in figure) to the first EES (110). In such a scenario, the first EES (110) act as the second EES to select the list of ACR mechanisms.

In an embodiment of the disclosure, the source EES (110) includes an ACR-cloud controller (340) coupled to a memory (310) and a processor (320). The ACR-cloud controller (340) is configured to receive a EAS discovery request message to perform a discovery operation from a source EAS (108). The EAS discovery request message includes an indication about the ACR to the cloud to provide information about the CAS (116) when the target EAS (108) is not available at the source EAS (108). Further, the ACR-cloud controller (340) is configured to send a retrieve EES request message towards the ECS (112) to identify at least one target EES (110) which has an EAS (108) available to serve the UE (124). The retrieve EES request message includes the indication about the ACR to the cloud or the indication to provide information about the CES. Further, the ACR-cloud controller (340) is configured to receive a response to the retrieve EES request from the ECS (112) where the response message includes the CES information. Further, the ACR-cloud controller is configured to send a response message to the source EAS (108) where the response message includes the CES information.

FIG. 4 is a block diagram of an EEC (104), according to an embodiment of the disclosure. The EEC (104) includes a memory (410), a processor (420), and an EEC controller (430). The EEC controller (430) receives the ACR notification message from the first EES (110). The EEC controller (430) selects the list of ACR mechanisms based on received ACR notification message.

The memory (410) is configured to store instructions to be executed by the processor (420). The memory (410) includes non-volatile storage elements. Examples of such non-volatile storage elements includes magnetic hard discs, optical discs, floppy discs, flash memories, or forms of EPROM or EEPROM memories. In addition, the memory (410) is considered for example, a non-transitory storage medium. The term “non-transitory” indicates that the storage medium is not embodied in a carrier wave or a propagated signal. The term “non-transitory” is not be interpreted that the memory (410) is non-movable. In some examples, the memory (410) is configured to store larger amounts of information. In certain examples, a non-transitory storage medium stores data that can, over time, change (e.g., in RAM or cache).

The processor (420) includes one or a plurality of processors. The one or the plurality of processors is a general-purpose processor, such as a CPU, an AP, or the like, a graphics processing unit such as a GPU, a VPU, and/or an AI-dedicated processor such as an NPU. The processor (420) includes multiple cores and is configured to execute the instructions stored in the memory (410).

The EEC controller (430) is implemented by processing circuitry such as logic gates, integrated circuits, microprocessors, microcontrollers, memory circuits, passive electronic components, active electronic components, optical components, hardwired circuits, or the like, and optionally be driven by firmware. The circuits for example, be embodied in one or more semiconductor chips, or on substrate supports such as printed circuit boards and the like.

At least one of the plurality of modules/components of the EEC controller (430) is implemented through an AI model. A function associated with the AI model is performed through the memory (410) and the processor (420). The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired char-acteristic is made. The learning is performed in a device itself in which AI according to an embodiment is performed, and/or is implemented through a separate server/system.

The AI model consist of a plurality of neural network layers. Each layer has a plurality of weight values and performs a layer operation through calculation of a previous layer and an operation of a plurality of weights. Examples of neural networks include, but are not limited to, CNN, DNN, RNN, RBM, DBN, BRDNN, GAN, and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

The EEC controller (430) includes an ACR mechanisms selector (432) and an ACR mechanisms detector (434). The EEC (104) receives the ACR notification message from the first EES (110). The ACR mechanisms selector (432) selects the list of ACR mechanisms based on received ACR notification message from the first EES (110).

In an embodiment of the disclosure, the EEC (104) initiating the ACR operation using the EEC performed ACR through the first EES (110). The ACR mechanisms selector (432) selects the list of ACR mechanisms based on the list of ACR mechanisms supported by the AC (102), the EEC (104), the second EES and the second EAS (108). The EEC (104) sends a request message to the first EES (110) in response to the initiation of the ACR operation. The request message includes the list of ACR mechanisms selected by the EEC (104). The first EES (110) determines initiation of the ACR operation includes the list of ACR mechanisms selected by the EEC (104) based on received request message from the EEC (104). The first EES (110) sends the push request message to the second EES that notifies the second EAS (108).

Referring to FIG. 4, the EEC (104) receives the ACR notification message from the first EES (110) of the plurality of EESs. The ACR notification message includes the list of identity of ACs, the second EAS profile, the second EES profile along with the list of ACR mechanisms selected by the second EES, supported ACR mechanisms by the second EAS (108), supported ACR mechanisms by the second EES. The EEC (104) determines whether the ACR mechanisms supported by the second EAS (108) and the ACR mechanisms supported by the second EES is available or not available. When the ACR mechanisms supported by the second EAS (108) and the ACR mechanisms supported by the second EES is available, the EEC (104) selects the list of ACR mechanisms based on received ACR notification message. When the ACR mechanisms supported by the second EAS (108) and the ACR mechanisms supported by the second EES is not available, the EEC (104) sends a request message to the first EES (110) for managing the ACR mechanisms selection based on received ACR notification message. The request message includes the ACR mechanisms supported by the EEC (104) and the ACR mechanisms supported by the AC (102).

In an embodiment of the disclosure, the EEC (104) performs an EAS discovery, a service provisioning, and an EES registration. During the EAS discovery, the EEC (104) has received candidate EASs as a response to the EAS discovery procedure and the EEC (104) selects the first EAS (108) from the discovered EAS candidates. The EEC (104) receives the ACR notification message from the first EES (110) to determine availability of the list of ACR mechanisms.

In an embodiment of the disclosure, the EES (110) determines whether the ACR mechanisms supported by the EEC (104) and the ACR mechanisms supported by the EAS (108) of a plurality of EASs is available for an EES (110) of the plurality of EESs. The EES (110) perform one of: selecting the list of ACR mechanisms and sending information of the list of ACR mechanisms selected by the EES (110) to the EEC (104) and the EAS (108) of the plurality of EASs, when the ACR mechanisms supported by the EEC (104) and the ACR mechanisms supported by the EAS (108) is available for the EES (110) and sending a request message to the EAS (108) for performing ACR selection, when the ACR mechanisms supported by the EAS (108) is not available for the EES (110). The request message includes the list of ACR mechanisms supported by the EEC (104) and the list of ACR mechanisms supported by the EES (110). The EAS (108) selects the list of ACR mechanisms based on the request message received from the EES (110).

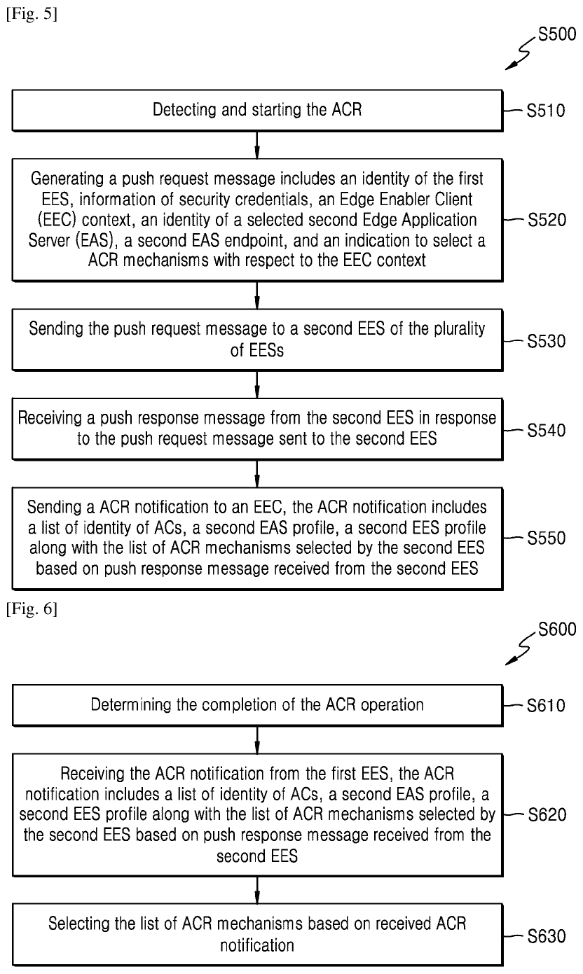

FIG. 5 is flow chart (S500) illustrating a method for sending the ACR notification message to the EEC (104), according to an embodiment of the disclosure. Referring to flow chart (S500), the first EES (110) sends required information to the second EES and to sends the selected ACR mechanisms to the EEC (104).

At S510, the method includes, determining the need for ACR is detected and the ACR is performed by ACR deciding entity (EEC (104) or first EES (110) or first EAS (108)) for the ACR mechanisms.

At S520, the method includes, generating the push request message includes the identity of the first EES (110), the information of security credentials, the EEC context, the identity of a selected second EAS (108), the second EAS (108) endpoint, the indication to select the ACR mechanisms with respect to the EEC context, and currently selected ACR mechanisms.

At S530, the method includes, sending the push request message to a second EESof the plurality of EESs. At S540, the method includes, receiving the push response message from the second EES in response to the push request message sent to the second EES.

At S550, the method includes, sending the ACR notification message to the EEC (104), the ACR notification message includes the list of identity of ACs, the second EAS profile, the second EES profile along with the list of ACR mechanisms selected by the second EES, supported ACR mechanisms by the second EAS (108), supported ACR mechanisms by the second EES based on the push response message received from the second EES.

In an embodiment of the disclosure, referring to FIG. 5, when the second EES accepts the already selected ACR mechanisms, the first EES (110) indicates the EEC (104) to continue using the already selected ACR mechanisms in the ACR complete notification or any other notification.

In an embodiment of the disclosure, from S510 to S550 of the FIG. 5 is applicable to all ACR mechanisms like the ACR initiation by the EEC (104) using EAS (108) Discovery, the EEC (104) performed ACR through the first EES (110), the first EES (110) decided the ACR mechanisms, the first EES (110) performed the ACR mechanisms and the EEC (104) performed the ACR through the second EES.

The various actions, acts, blocks, steps, or the like in the flow chart (S500) is performed in the order presented, in a different order or simultaneously. Further, in some embodiments, some of the actions, acts, blocks, steps, or the like are omitted, added, modified, skipped, or the like without departing from the scope of the proposed method.

FIG. 6 is flow chart (S600) illustrating a method for selecting the list of ACR mechanisms based on received ACR notification message, according to an embodiment of the disclosure. Referring to flow chart (S600), the first EES (110) sends required information to the EEC (104) during ACR.

At S610, the method includes, determining the completion of the ACR operation. When the first EES (110) decided ACR mechanisms or the first EES (110) performed ACR mechanisms, the first EES (110) has received Application Context Transfer (ACT) status update notification to indicate successful ACR.

At S620, the method includes, receiving the ACR notification message from the first EES (110) for enabling the EEC (104) to select the ACR mechanisms for the AC (102), the EEC (104), the second EES and the second EAS pair, the ACR notification message includes the list of identity of ACs, the second EAS profile, a second EES profile along with the list of ACR mechanisms selected by the second EES based on push response message received from the second EES.

At S630, the method includes, selecting the list of ACR mechanisms based on received ACR notification message from the first EES (110).

In an embodiment of the disclosure, from S610 to S630 of the FIG. 6 is applicable to all ACR mechanisms like the ACR initiation by the EEC (104) using EAS Discovery, the EEC (104) performed ACR through the first EES (110), the first EES (110) decided the ACR mechanisms, the first EES (110) performed the ACR mechanisms and the EEC (104) performed the ACR through the second EES.

The various actions, acts, blocks, steps, or the like in the flow chart (S600) is performed in the order presented, in a different order or simultaneously. Further, in some embodiments, some of the actions, acts, blocks, steps, or the like are omitted, added, modified, skipped, or the like without departing from the scope of the proposed method.

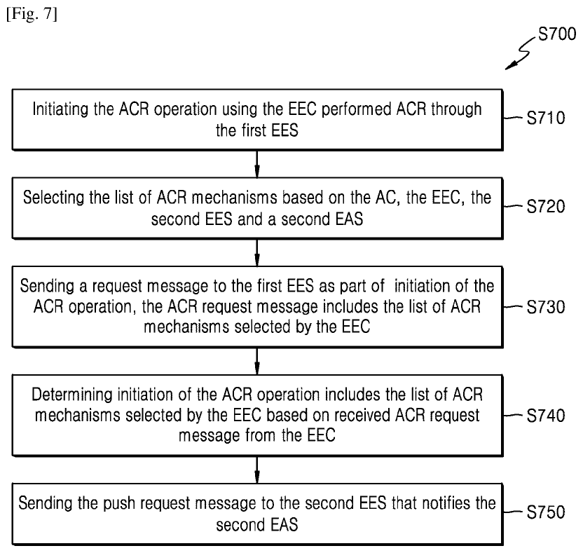

FIG. 7 is flow chart (S700) illustrating a method for sending a push request message to the second EES, according to an embodiment of the disclosure.

At S710, the method includes, the initiating the ACR operation using the EEC (104) performed ACR through the first EES (110). At S720, the method includes, selecting the list of ACR mechanisms based on the AC (102), the EEC (104), the second EES and a second EAS (108).

At S730, the method includes, sending the request message to the first EES (110) in response to the initiation of the ACR operation. The request message includes the list of ACR mechanisms selected by the EEC (104). At S740, the method includes, determining initiation of the ACR operation includes the list of ACR mechanisms selected by the EEC (104) based on received request message from the EEC (104).

At S750, the method includes, sending the push request message to the second EES that notifies the second EAS (108). The push request message includes the identity of the first EES (110), the information of security credentials, the EEC context, the identity of a selected second EAS (108), the second EAS (108) endpoint, and the indication to select the ACR mechanisms with respect to the EEC context.

In an embodiment, from S710 to S750 of the FIG. 7 is applicable to all ACR mechanisms like the ACR initiation by the EEC (104) using EAS (108) Discovery, the EEC (104) performed ACR through the first EES (110), the first EES (110) decided the ACR mechanisms, the first EES (110) performed the ACR mechanisms and the EEC (104) performed the ACR through the second EES.

The various actions, acts, blocks, steps, or the like in the flow chart (S700) is performed in the order presented, in a different order or simultaneously. Further, in some embodiments, some of the actions, acts, blocks, steps, or the like are omitted, added, modified, skipped, or the like without departing from the scope of the proposed method.

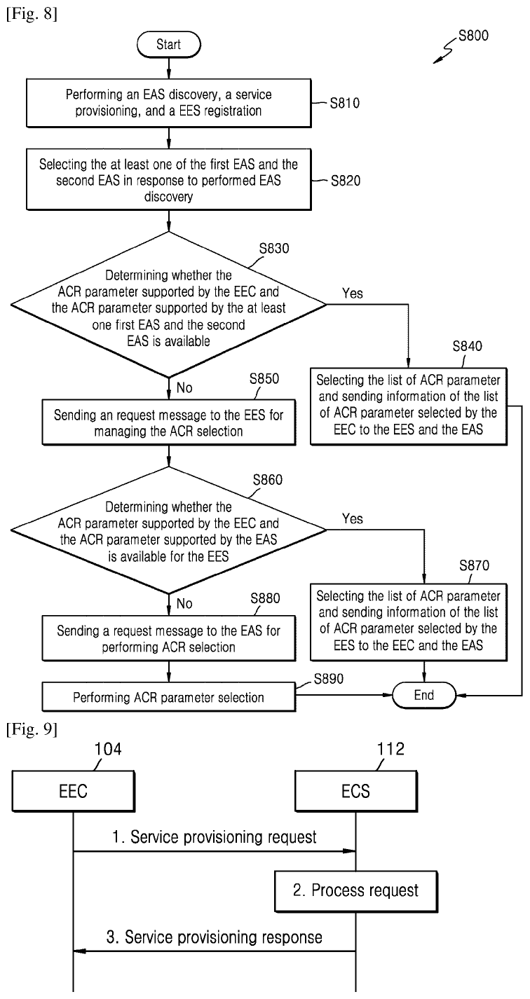

FIG. 8 is a flow chart (S800) illustrating a method for sending a request message to the second EAS (108) for performing ACR selection, according to an embodiment of the disclosure.

At S810, the method includes performing an EAS (108) discovery, a service provisioning, and an EES registration. At S820, the method includes selecting the EAS (108) in response to performed EAS (108) discovery. At S830, the method includes determining whether the ACR mechanisms supported by the EAS (108) and the ACR mechanisms supported by the EES (110) is available.

At S840, the method includes selecting the list of ACR mechanisms, when the ACR mechanisms supported by the second EAS (108) and the ACR mechanisms supported by the second EES is available. Also, the method includes sending information of the list of ACR mechanisms selected by the EEC (104) to the EES (110) and the EAS (108).

At S850, the method includes sending a request message to the first EES (110) for managing the ACR mechanisms selection, when one of the ACR mechanisms supported by the second EES and the ACR mechanisms supported by the second EAS (108) is not available. The request message includes the ACR mechanisms supported by the EEC (104) and the ACR mechanisms supported by the AC (102).

At S860, the method includes determining whether the ACR mechanisms supported by the EEC (104) and the ACR mechanisms supported by the EAS (108) is available for the EES (110).

At S870, the method includes selecting the list of ACR mechanisms and sending information of the list of ACR mechanisms selected by the EES (110) to the EEC (104) and the EAS (108), when the ACR mechanisms supported by the EEC (104) and the ACR mechanisms supported by the EAS (108) is available for the EES (110).

At S880, the method includes sending the request message to the EAS (108) for performing ACR selection. At S890, the method includes performing ACR mechanisms selection.

In an embodiment of the disclosure, from S810 to S890 of the FIG. 8 is applicable to all ACR mechanisms like the ACR initiation by the EEC (104) using EAS (108) Discovery, the EEC (104) performed ACR through the first EES (110), the first EES (110) decided the ACR mechanisms, the first EES (110) performed the ACR mechanisms and the EEC (104) performed the ACR through the second EES.

The various actions, acts, blocks, steps, or the like in the flow chart (S800) is performed in the order presented, in a different order or simultaneously. Further, in some embodiments, some of the actions, acts, blocks, steps, or the like are omitted, added, modified, skipped, or the like without departing from the scope of the proposed method.

In an embodiment of the disclosure, the source EES (110) notifying the EEC (104) about EES profile, supported ACR mechanisms and EAS profile to enable source EES (110) to perform new ACR mechanisms selection. The EEC (104) selecting the ACR mechanisms upon receiving the ACR notification message from the source EES (110). The source EES (110) indicating second EAS (108) identifier and an indication to select new ACR mechanisms to the target EES. Upon receiving the push request message from the source EES (110), the target EES selecting the new ACR mechanisms. The target EES sends newly selected ACR mechanisms to the source EES (110) in push response message. The source EES (110) notifying the EEC (104) about newly selected ACR mechanisms as selected by the target EES. The EEC (104) informing selected ACR mechanisms and target EES details to the source EES (110). The source EES (110) informing selected ACR mechanisms to the target EES.

In the embodiment of the disclosure, in order to provide sufficient information to the EEC (104) to select the ACR mechanisms after service continuity is successfully completed, the source EES (110) sends the ACR notification message to the EEC (104). The ACR notification message includes the target EES profile and the target EAS profile along with the list of ACR mechanisms supported by the by the target EES. The EEC (104) performs the ACR mechanisms selection upon receiving the ACR notification message with the target EES and target EAS profiles.

After service continuity is successfully completed, in order to provide sufficient information to the target EES to select ACR mechanisms, the source EES (110) sends the push request message to the target EES. The push request message includes selected identity of the target EAS, target EAS endpoint and indication to select ACR mechanisms. Upon receiving the push request message from the source EES (110), the target EES selects ACR mechanisms.

In the embodiment of the disclosure, the source EES (110) sends the ACR notification message to the EEC (104) that includes the ACR mechanisms as selected by the target EES.

In an embodiment of the disclosure, after discovering the target EAS and the target EES, the EEC (104) selects the ACR mechanisms list based on the target EES, the target EAS the AC (102) and the EEC (104) supported ACR mechanisms. The EEC (104) sends the request message to the source EES (110). The request message includes target EES endpoint, and newly selected ACR mechanisms. The source EES (110) sends the push request message to the target EES. The push request message includes the list of ACR mechanisms selected by the EEC (104).

In the embodiment of the disclosure, the EEC (104) performs the ACR mechanisms selection when Supported ACR mechanisms are available for all entities (AC (102), EEC (104), EES (110) and second EAS (108)). When supported ACR mechanisms are not available for the target EES or target EAS (108), the EEC (104) requests the source EES (110) to perform ACR mechanisms selection by providing the AC (102) and the list of ACR mechanisms supported by the EEC (104).

In the embodiment of the disclosure, when supported ACR mechanisms are not available for the second EAS (108), the first EES (110) request the EAS (108) to perform ACR mechanisms selection by providing the list of ACR mechanisms supported by the AC (102), the EEC (104) and the EES (110). When supported ACR mechanisms are not available for target EAS (108), the target EES requests the target EAS to perform ACR mechanisms selection by providing the list of ACR mechanisms supported by the AC (102), the EEC (104) and the target EES.

FIG. 9 illustrates service provisioning procedure based on request/response model, according to an embodiment of the disclosure.

In an embodiment of the disclosure, the EEC (104) sends a service provisioning request to the ECS (112). The service provisioning request includes the security credentials of the EEC (104) received during EEC authorization procedure and may include the UE identifier such as Generic Public Subscription Identifier (GPSI), con-nectivity information, UE location and AC profile(s) information. When service provisioning request is initiated for ACR to Cloud, the EEC (104) also includes indication about ACR to Cloud in the request.

Upon receiving the request, the ECS (112) performs an authorization check to verify whether the EEC (104) has authorization to perform the operation.

The ECS (112) also determines other information that needs to be provisioned, e.g. identification of the EDN (114), EDN service area, EES endpoints.

In an embodiment of the disclosure, when the processing of the request was successful, the ECS (112) responds to the EEC's request with a service provisioning response which includes a list of EDN configuration information, e.g. identification of the EDN (114), EDN service area, and the required information (e.g. URI, IP address) for establishing a connection to the EES (110). When the ECS (112) is not provisioned with any EDN configuration information or is unable to determine the EES (110) information using the inputs in service provisioning request, UE-specific service information at the ECS (112) or the ECS policy, and when CES is not registered to ECS (112) the ECS (112) shall reject the service provisioning request and respond with an appropriate failure cause.

When CES is registered to the ECS (112) and the EEC (104) indicated ACR to Cloud in the service provisioning request, then ECS (112) may include CES information in the service provisioning response. Otherwise, the ECS (112) shall reject the service provisioning request and respond with an appropriate failure cause. In an embodiment of the disclosure, the ECS (112) provides the CES information when EES (110) is not found, based on local policy or configuration. In an embodiment of the disclosure, the ECS (112) provides the CES information in the Service provisioning notification, based on indication or local policy or configuration. In an embodiment of the disclosure, the EEC (104) can provide the indication (about ACR to cloud or to provide CAS information) in EAS (108) discovery message or EEC registration message or any other message.

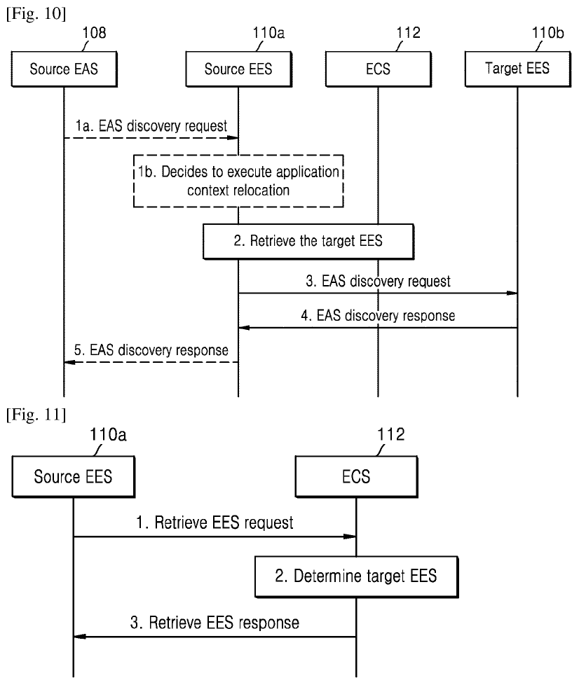

FIG. 10 illustrates procedure for fetching T-EAS information, according to an embodiment of the disclosure. This procedure may be utilized by a S-EAS (108), which undertakes the transfer of application context information to a T-EAS directly, or can be invoked by the S-EES (110a) itself on deciding to execute ACR.

The S-EAS (108) sends the EAS (108) discovery request to the S-EES (110a) or the S-EES (110a) decides to execute the ACR. The EAS (108) discovery request from the S-EAS (108) includes the requestor identifier [EAS ID] along with the security credentials and includes EAS (108) discovery filter matching its EAS profile.

When the request is received from the S-EAS (108), the S-EES (110a) checks whether the requesting EAS (108) is authorized to perform the discovery operation. When the S-EES (110a) decided to execute the ACR or when the requesting EAS (108) is authorized, the S-EES (110a) checks when there exists a T-EAS information (registered or cached) that can satisfy the requesting EAS (108) information, additional query filters and the Expected service Key Performance Indicators (KPIs) and the Minimum required service KPIs when received from the EEC (104) during the EAS (108) discovery or from the S-EAS (108) in step 1. When the S-EES (110a) finds the T-EAS(s) in the cached or registered information, the flow either continues with step 5 for the S-EAS (108) triggered discovery or stops for the S-EES (110a) decided ACR execution, else the S-EES (110a) retrieves the T-EES (110b) address from the ECS (112) as specified in clause 8.8.3.3 and continues with step 3.

The S-EES (110a) invokes the EAS (108) discovery request on the T-EES (110b) retrieved from the ECS (112). The EAS (108) discovery request includes the requestor identifier [EESID] along with the security credentials and includes EAS (108) discovery filter.

The T-EES (110b) discovers the T-EAS (s) and responds with the discovered T-EAS information to the S-EES (110a). When the request was received from the S-EAS (108), the S-EES (110a) responds to the S-EAS (108) with the discovered T-EAS Information.

When Discover T-EAS (108) fails to return T-EAS (108), then S-EAS (108) may include the indication about ACR to Cloud and repeat the Discover T-EAS procedure. In an embodiment of the disclosure, S-EAS (108) may include the indication in the Discover T-EAS request for S-EES (110a) to provide CAS information, when the T-EAS (108) is not found.

FIG. 11 illustrates the procedure for the S-EES (110a) to retrieve the T-EES information from the ECS (112), according to an embodiment of the disclosure.

The S-EES (110a) sends the Retrieve EES request (UE location information or UE identity, EAS ID of the S-EAS (108), target DNAI) to the ECS (112) in order to identify the T-EES which has an EAS (108) available to serve the given the AC (102) in the UE (124). When Retrieve EES request is initiated for ACR to Cloud, the S-EES (110a) also includes indication about ACR to Cloud in the request. The ECS (112) determines T-EES(s) as per the parameters (e.g. EAS ID, target DNAI) in the request and the UE location information. The ECS (112) sends the Retrieve EES response including the list of EDN configuration information to the S-EES (110a). The list of EDN configuration information includes the EDN details with the endpoint information of T-EES(s).

When CES is registered to ECS (112) and S-EES (110a) indicated ACR to Cloud in the Retrieve EES request, then ECS (112) may include CES information in the Retrieve EES response. Otherwise, the ECS (112) shall reject the Retrieve EES request and respond with an appropriate failure cause. In an embodiment of the disclosure, S-EES (110a) may include the indication in the Retrieve EES request for ECS (112) to provide CES information when T-EES is not found. In an embodiment of the disclosure, the ECS (112) provides the CES information when T-EES is not found, based on local policy and/or configuration. Please note that the Retrieve EES request initiated by the S-EES (110a) can be restricted only to its registered ECS (112).

Enhancements to Solution #24: ACR between the EAS (108) and the CAS (116) with CES (clause 7.24 of 3GPP TR 23.700-98 V1.3.0).

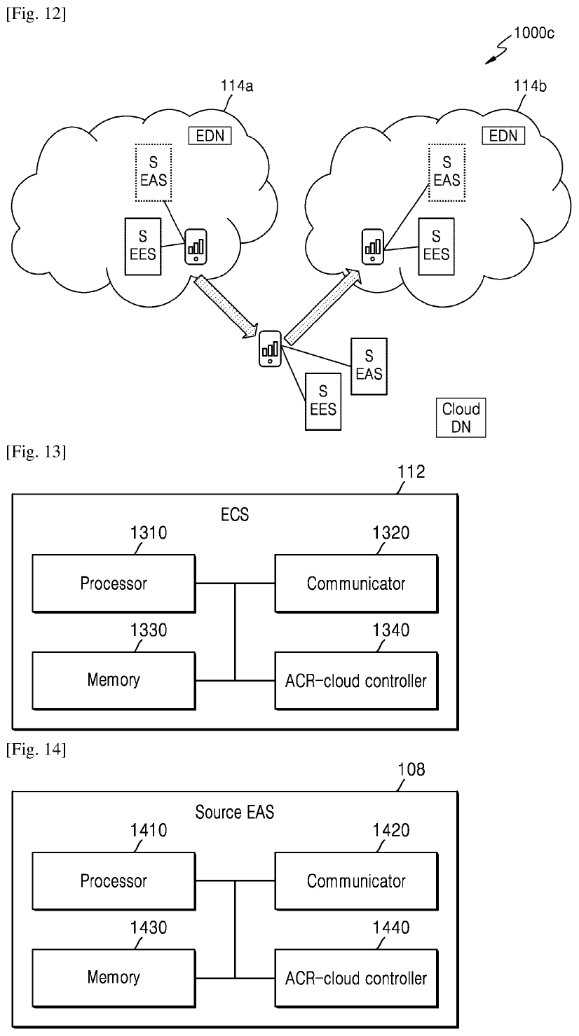

FIG. 12 illustrates the UE (124) moving from one EDN (114a) to Cloud DN then to another EDN (114b), according to an embodiment of the disclosure. As depicted in FIG. 12, since the EAS (108) may have service area restriction, once the UE (124) is moving out of the current edge coverage, to keep service continuity, the application client (AC) (102) needs to connect to either another EAS (108) in new EDN (114) or the CAS (116). For the latter case, when the CES (118) is deployed and EAS (108) indicates S-EES (110) about ACR to Cloud, the S-EES (110) interacts with the CES (118) via EDGE-9′ reference point and application context is transferred between the S-EAS (108) and the CAS (116). Later, when the UE (124) is moving to an area with edge coverage, the CES (118) interacts with the EES (110) via EDGE-9′ reference point and application context is transferred between the CAS (116) and EAS (108).

Further, ACR scenarios is described herein. The ACR scenarios in TS 23.558 V18.0.0 can be extended to include ACR between EAS (108) and CAS (116), with the clarification that when CES (118) is deployed, EEL interacts with the CES (118) to handle application context transfer or another mechanism (e.g. DNS query) depends on the indication from the AC (102) or EAS (108). The extension would also include ex-tensions to relevant procedures used in the ACR Scenarios (e.g. Service provisioning, T-EAS discovery, ACR request).

FIG. 13 shows various hardware components of the ECS (112), according to an embodiment of the disclosure. In an embodiment of the disclosure, the ECS (112) includes a processor (1310), a communicator (1320), a memory (1330) and an ACR-cloud controller (1340). The processor (1310) is coupled with the communicator (1320), the memory (1330) and the ACR-cloud controller (1340).

In an embodiment of the disclosure, the ACR-cloud controller (1340) receives the service provision request message to perform the service provision operation from the EEC (104). The service provisioning request includes the indication about the ACR to the cloud or the indication to provide information about the CES (118). The ACR-cloud controller (1340) authorizes whether the EEC (104) has authorization to perform the service provision operation based on the service provision request message. Further, the ACR-cloud controller (1340) determines whether the CES (118) is registered to the ECS (112). In an embodiment of the disclosure, the ACR-cloud controller (1340) sends the service provision response message to the ECS (112) when the CES (118) is registered to the ECS (112), the authorization of the EEC (104) is successful and the request from the EEC (104) includes the indication about the ACR to the cloud. The service provision response message includes information about the CES (118). In an embodiment of the disclosure, the ACR-cloud controller (1340) sends the service provision reject message with the cause when at least one of the authorization of the ECS (112) is unsuccessful and the CES (118) is not registered to the ECS (112).

In an embodiment of the disclosure, the ACR-cloud controller (1340) receives the retrieve EES request message from the source EES (110) to identify at least one target EES which has the EAS (108) available to serve the UE (124). The retrieve EES request message includes the indication about the ACR to the cloud or the indication to provide information about the CES (118). Further, the ACR-cloud controller (1340) determines whether the CES (118) is registered to the ECS (112). In an embodiment of the disclosure, the ACR-cloud controller (1340) sends the retrieve EES response message to the ECS (112) when the CES (118) is registered with the ECS (112) and the request message includes an indication about the ACR to the cloud. The retrieve EES response message includes information about the CES information. In an embodiment of the disclosure, the ACR-cloud controller (1340) sends the retrieve EES reject message with the cause, when the CES (118) is not registered with the ECS (112).

The ACR-cloud controller (1340) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (1310) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (1310) may include multiple cores and is configured to execute the instructions stored in the memory (1330).

Further, the processor (1310) is configured to execute instructions stored in the memory (1330) and to perform various processes. The communicator (1320) is configured for communicating internally between internal hardware components and with external devices via one or more networks. The memory (1330) also stores instructions to be executed by the processor (1310). The memory (1330) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (1330) may, in some examples, be considered a non-transitory storage medium. The term “non-transitory” may indicate that the storage medium is not embodied in a carrier wave or a propagated signal. However, the term “non-transitory” should not be interpreted that the memory (1330) is non-movable. In certain examples, a non-transitory storage medium may store data that can, over time, change (e.g., in Random Access Memory (RAM) or cache).

Although the FIG. 13 shows various hardware components of the ECS (112) but it is to be understood that other embodiments are not limited thereon. In an embodiment of the disclosure, the ECS (112) may include less or more number of components. Further, the labels or names of the components are used only for illustrative purpose and does not limit the scope of the invention. One or more components can be combined together to perform same or substantially similar function in the ECS (112).

FIG. 14 shows various hardware components of the source EAS (108), according to an embodiment of the disclosure. In an embodiment of the disclosure, the source EAS (108) includes a processor (1410), a communicator (1420), a memory (1430) and an ACR-cloud controller (1440). The processor (1410) is coupled with the communicator (1420), the memory (1430) and the ACR-cloud controller (1440).

The ACR-cloud controller (1440) determines the first discovery operation for the target EAS failing to return the target EAS. Further, the ACR-cloud controller (1440) performs a second discover operation by sending the EAS (108) discovery request message to the source EES (110). The EAS (108) discovery request message includes the indication about the ACR to the cloud to provide information about the CAS (116). Further, the ACR-cloud controller (1440) receives the EAS (108) discovery response message from the source EES (110). The EAS (108) discovery response message includes information about the target EAS associated with the target EES.

The ACR-cloud controller (1440) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (1410) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (1410) may include multiple cores and is configured to execute the instructions stored in the memory (1430).

Further, the processor (1410) is configured to execute instructions stored in the memory (1430) and to perform various processes. The communicator (1420) is configured for communicating internally between internal hardware components and with external devices via one or more networks. The memory (1430) also stores instructions to be executed by the processor (1410). The memory (1430) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (1430) may, in some examples, be considered a non-transitory storage medium. The term “non-transitory” may indicate that the storage medium is not embodied in a carrier wave or a propagated signal. However, the term “non-transitory” should not be interpreted that the memory (1430) is non-movable. In certain examples, a non-transitory storage medium may store data that can, over time, change (e.g., in Random Access Memory (RAM) or cache).

Although the FIG. 14 shows various hardware components of the source EAS (108) but it is to be understood that other embodiments are not limited thereon. In an embodiment of the disclosure, the source EAS (108) may include less or more number of components. Further, the labels or names of the components are used only for illustrative purpose and does not limit the scope of the invention. One or more components can be combined together to perform same or substantially similar function in the source EAS (108).

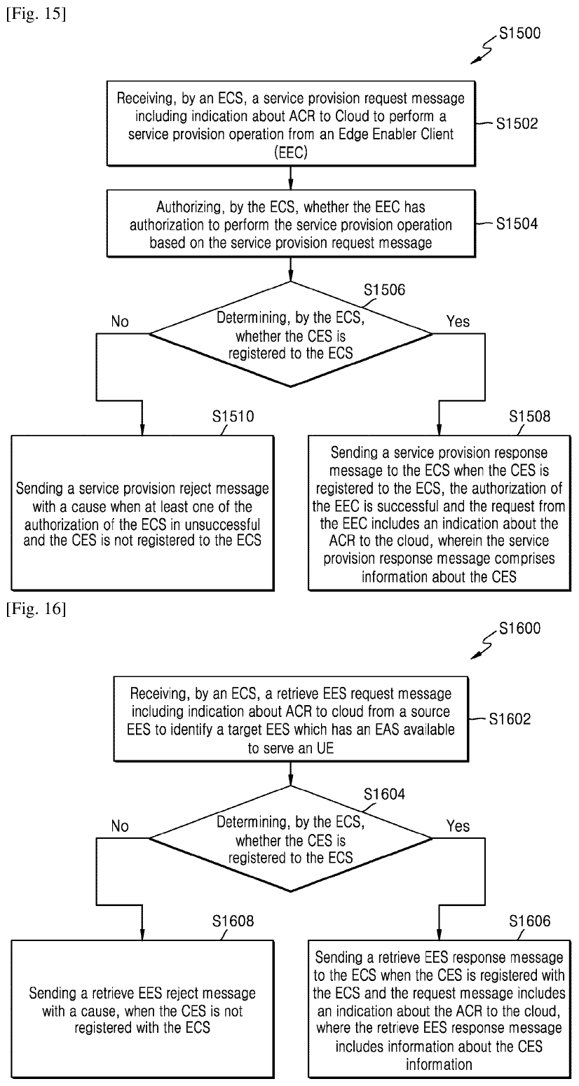

FIG. 15 is a flow chart (S1500) illustrating a method, implemented by the ECS (112), for managing the ACR to the cloud, according to an embodiment of the disclosure. The operations (S1502-S1510) are handled by the ACR-cloud controller (1340).

At S1502, the method includes receiving the service provision request message to perform the service provision operation from the EEC (104). The service provisioning request includes an indication about the ACR to the cloud or the indication to provide information about the CES (118). The request message includes indication about ACR to Cloud. At S1504, the method includes authorizing whether the EEC (104) has authorization to perform the service provision operation based on the service provision request message. At S1506, the method includes determining whether the CES (118) is registered to the ECS (112). In an embodiment of the disclosure, at S1508, the method includes sending the service provision response message to the ECS (112) when the CES (118) is registered to the ECS (112), the authorization of the EEC (104) is successful and the request from the EEC (104) includes an indication about the ACR to the cloud. The service provision response message includes information about the CES (118). In an embodiment of the disclosure, at S1510, the method includes sending the service provision reject message with a cause when at least one of the authorization of the ECS (112) is unsuccessful and the CES (118) is not registered to the ECS (112).

In an embodiment of the disclosure, the indication about the ACR to the cloud or the indication to provide information about the CES (118) is included in one of an Edge Application Server (EAS) discovery message and a EEC registration message.

FIG. 16 is another flow chart (S1600) illustrating a method, implemented by the ECS (112), for managing the ACR to the cloud, according to an embodiment of the disclosure. The operations (S1602-S1608) are handled by the ACR-cloud controller (1340).

At S1602, the method includes receiving the retrieve EES request message from the source EES (110) to identify the target EES which has an EAS (108) available to serve the UE (124). The retrieve EES request message includes the indication about the ACR to the cloud or an indication to provide information about the CES (118). The request message includes indication about ACR to Cloud. At S1604, the method includes determining whether the CES (118) is registered to the ECS (112). In an embodiment of the disclosure, at S1606, the method includes sending the retrieve EES response message to the ECS (112) when the CES (118) is registered with the ECS (112) and the request message includes an indication about the ACR to the cloud. The retrieve EES response message includes information about the CES information. In an embodiment of the disclosure, at S1608, the method includes sending a retrieve EES reject message with a cause, when the CES (118) is not registered with the ECS (112).

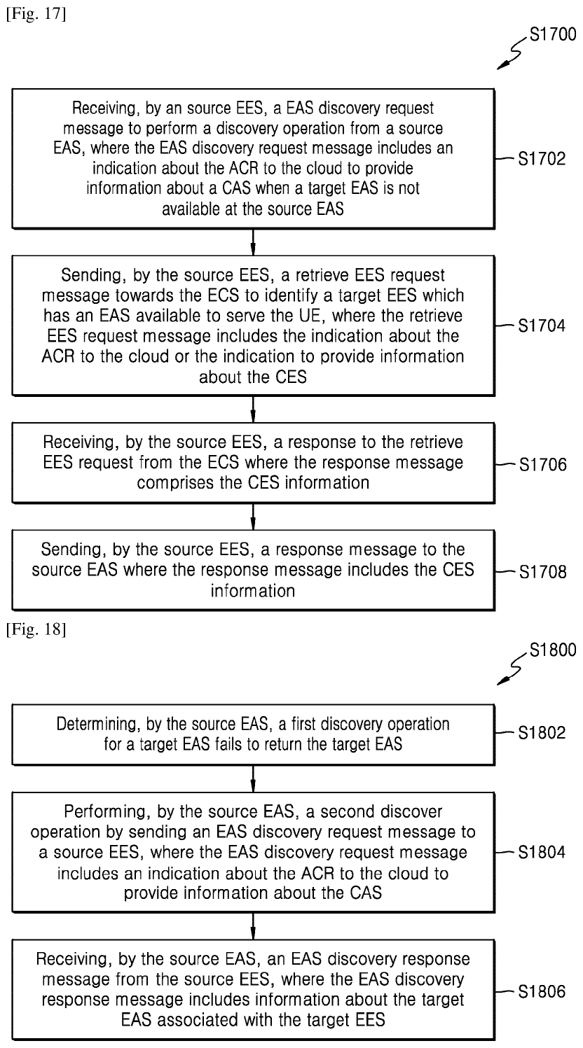

FIG. 17 is a flow chart (S1700) illustrating a method, implemented by the source EES (110), for managing the ACR to the cloud, according to an embodiment of the disclosure. The operations (S1702-S1708) are handled by the ACR-cloud controller (340).

At S1702, the method includes receiving the EAS (108) discovery request message to perform the discovery operation from the source EAS (108). The EAS (108) discovery request message includes the indication about the ACR to the cloud to provide information about the CAS (116) when at least one target EAS (108) is not available at the source EAS (108). At S1704, the method includes sending the retrieve EES request message towards the ECS (112) to identify at least one target EES which has the EAS (108) available to serve the UE (124). The EES request message includes the indication about the ACR to the cloud or the indication to provide information about the CES (118). At S1706, the method includes receiving the response to the retrieve EES request from the ECS (112) where the response message includes the CES information. At S1708, the method includes sending the response message to the source EAS (108) where the response message includes the CES information.

FIG. 18 is a flow chart (S1800) illustrating a method, implemented by the source EAS (108), for managing the ACR to the cloud, according to an embodiment of the disclosure. The operations (S1802-S1806) are handled by the ACR-cloud controller (1440).

At S1802, the method includes determining the first discovery operation for the target EAS (108) failing to return the target EAS (108). At S1804, the method includes performing the second discover operation by sending the EAS (108) discovery request message to the source EES (110). The EAS (108) discovery request message includes the indication about the ACR to the cloud to provide information about the CAS (116). At S1806, the method includes receiving the EAS (108) discovery response message from the source EES (110). The EAS discovery response message includes information about at least one target EAS associated with the target EES.

The various actions, acts, blocks, steps, or the like in the flow charts (S500-S800 and S1500-S1800) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method performed by a first edge enabler server (EES), the method comprising:
transmitting, to a second EES, a first message requesting an application context relocation (ACR) scenario selection;
receiving, from the second EES, a second message in response to the first message, wherein the second message comprises a list of ACR scenarios selected by the second EES; and
transmitting, to an edge enabler client (EEC), a third message comprising the list of ACR scenarios selected by the second EES based on the second message.

17. The method of claim 16, wherein the first message comprises an identifier ID of the first EES, information of security credentials, an EEC context, a second edge application server (EAS) endpoint, and an indication to select an ACR scenario.

18. The method of claim 17, wherein the first message is validated by the second EES, and the information of security credentials is verified by the second EES.

19. The method of claim 16, wherein the list of ACR scenarios selected by the second EES are selected from a plurality of ACR scenarios based on second EES capabilities and second EAS capabilities.

20. A method performed by a second edge enabler server (EES), the method comprising:
receiving, from a first EES, a first message requesting an application context relocation (ACR) scenario selection;
selecting at least one ACR scenario from a plurality of ACR scenarios;
obtaining a list of ACR scenarios based on the selected at least one ACR scenario; and
transmitting, to the first EES, a second message in response to the first message, wherein the second message comprises the list of ACR scenarios.

21. The method of claim 20, wherein the first message comprises an identifier of the first EES, information of security credentials, an EEC context, a second edge application server (EAS) endpoint, and an indication to select an ACR scenario.

22. The method of claim 21, further comprising:
validating the first message; and
verifying the information of security credentials.

23. The method of claim 20, wherein the selecting of the at least one ACR scenario is based on second EES capabilities and second EAS capabilities.

24. A method performed by an edge enabler client (EEC), the method comprising:
receiving, from a first edge enabler server (EES), a third message comprising a list of application context relocation (ACR) scenarios selected by a second EES; and
selecting an ACR scenario based on supported ACR scenarios of an application client (AC), the EEC, a second EES, and a second edge application server (EAS).

25. The method of claim 24, wherein the ACR scenario is selected in case that the list of ACR scenarios selected by the second EES is not available.

26. The method of claim 24,
wherein the third message is based on a second message transmitted from the second EES to the first EES,
wherein the second message comprises the list of ACR scenarios selected by the second EES.

27. The method of claim 24, wherein the list of ACR scenarios selected by the second EES are selected from a plurality of ACR scenarios based on second EES capabilities and second EAS capabilities.

28. A first edge enabler server (EES) comprising:
a transceiver; and
at least one processor coupled to the transceiver, configured to:
transmit, through the transceiver, to a second EES, a first message requesting an application context relocation (ACR) scenario selection,
receive, through the transceiver, from the second EES, a second message in response to the first message, wherein the second message comprises a list of ACR scenarios selected by the second EES,
transmit, through the transceiver, to an edge enabler client (EEC), a third message comprising the list of ACR scenarios selected by the second EES based on the second message.

29. The first EES of claim 28, wherein the first message comprises an identifier ID of the first EES, information of security credentials, an EEC context, a second edge application server (EAS) endpoint, and an indication to select an ACR scenario.

30. The first EES of claim 29, wherein the first message is validated by the second EES, and the information of security credentials is verified by the second EES.

31. The first EES of claim 28, wherein the list of ACR scenarios selected by the second EES are selected from a plurality of ACR scenarios based on second EES capabilities and second EAS capabilities.
